(19) United States
(12) Patent Application Publication
(10) Pub. No.: US 2007/0101376 A1
(43) Pub. Date: May 3, 2007

(54) INFORMATION PROCESSING APPARATUS AND METHOD, PROGRAM, RECORDING MEDIUM, AND CONTENT PROCESSING APPARATUS AND METHOD

(75) Inventors: Shuichi Otsu, Kanagawa (JP); Junichi Nakamura, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/552,191

(22) Filed: Oct. 24, 2006

(30) Foreign Application Priority Data
Nov. 2, 2005 (JP) 2005-319178

(51) Int. Cl. H04N 7/173; H04N 7/18

(52) U.S. Cl. 725/86; 725/90; 725/81; 725/87; 725/100; 725/131

(57) ABSTRACT

The present invention relates to an information processing apparatus that communicates with a content processing apparatus for executing a process related to recording or playback of content and has a display unit for displaying information. The information processing apparatus includes a schedule-information acquisition section acquiring schedule information regarding a recording and/or viewing schedule set up in the content processing apparatus, a result-information acquisition section acquiring result information regarding the result of recording performed in accordance with the schedule information set up in the content processing apparatus, and a display section displaying the schedule information acquired by the schedule-information acquisition section or the result information acquired by the result-information acquisition section in a predetermined form on the display unit.

### CROSS REFERENCES TO RELATED APPLICATIONS

The present invention contains subject matter related to Japanese Patent Application JP 2005-319178 filed in the Japanese Patent Office on Nov. 2, 2005, the entire contents of which are incorporated herein by reference.

### BACKGROUND OF THE INVENTION

1. Field of the Invention

The present invention relates to information processing apparatuses and methods, programs, recording media, and content processing apparatuses and methods, and more particularly, to an information processing apparatus and method, a program, a recording medium, and a content processing apparatus and method which are capable of providing information regarding a recording schedule to a user, who is viewing a program, in a more understandable way.

2. Description of the Related Art

Recorders having a function for receiving a broadcast wave, such as a television broadcast wave, and recording a received program onto a recording medium, such as a tape or a disk, are in widespread use. Various features for recording broadcast programs the user desires are proposed.

To prepare to record a broadcast program, generally, the user checks broadcast programs to be aired using a program listing provided by a medium, such as a newspaper, obtains information necessary for recording programming, and programs a recorder to record a desired program. However, this way of recording programming is often complicated. The user may make a mistake in programming the recorder. Unfortunately, the user may fail to record a broadcast program the user desires. If the contents of broadcast program service or airtime changes, the user may fail to record the desired program.

Various video recorders designed to solve the above-described problems are introduced. For example, one video recorder allows a television (TV) monitor to graphically display setup information necessary for recording programming so that the user readily confirms and inputs the information, thus preventing an error in operation. Since program listings in newspapers include unique numbers (G-Codes) each specifying a broadcasting station (channel) and its program information, another video recorder enables a user to set up a recording schedule by entering a unique number using a remote control of the video recorder.

In addition, a service to send information regarding programs to be broadcast to video recorders by distributing broadcast program information through communication channels, such as a broadcast wave and a network, has started. For example, Japanese Unexamined Patent Application Publication No. 2004-135356 discloses a system capable of graphically displaying such information on a TV monitor. Accordingly, recording programming has become easy.

In addition, the following improved functions are introduced. One function enables to keep up with a change in the contents of broadcast program service or airtime by continuously monitoring the broadcast program information. Another function enables automatic recording of a broadcast program having a high degree of association with set keywords representing user preferences on the basis of broadcast program information regarding programs to be aired.

### SUMMARY OF THE INVENTION

As described above, various functions to make recording programming easier are realized. To make these functions more user friendly, displaying broadcast program information, displaying and inputting information for setting up a recording schedule, and displaying information for confirming the set up recording schedule or the result of recording are important factors for the improvement of the convenience of users. Since it is difficult for a general text display device provided for a video recorder to display all of the above-described information, the information is often displayed on a display device, such as a display of a television receiver, used in enjoying a recorded program.

Disadvantageously, it may be impossible for the user to set up a recording schedule using the above-described recording programming function while viewing content, such as a broadcast program.

The present invention is made in consideration of the above-described problems and it is desirable to provide a mechanism capable of providing information regarding a recording schedule to a user, who is viewing a program, in an understandable way.

According to an embodiment of the present invention, there is provided an information processing apparatus that communicates with a content processing apparatus for executing a process related to recording or playback of content and has a display unit for displaying information. The information processing apparatus includes the following elements: A schedule-information acquisition section acquires schedule information regarding a recording and/or viewing schedule set up in the content processing apparatus. A result-information acquisition section acquires result information regarding the result of recording performed in accordance with the schedule information set up in the content processing apparatus. A display section displays the schedule information acquired by the schedule-information acquisition section or the result information acquired by the result-information acquisition section in a predetermined form on the display unit.

The content includes programs for broadcast. The information processing apparatus may further include the following elements: A program-information acquisition section acquires program information regarding the programs from an information management device connected via a network. A program-listing generation section generates display data for a program listing on the basis of the program information acquired by the program-information acquisition section.

The display section may display part or all of the schedule information acquired by the schedule-information acquisition section or the result information acquired by the result-information acquisition section together with the program listing corresponding to the display data generated by the program-listing generation section.

The schedule information acquired by the schedule-information acquisition section or the result information acquired by the result-information acquisition section may be displayed as a predetermined mark or character on the program listing.

The display section may display part or all of the schedule information acquired by the schedule-information acquisition section or the result information acquired by the result-information acquisition section as a list.

The schedule information acquired by the schedule-information acquisition section or the result information acquired by the result-information acquisition section may be displayed as a predetermined mark or character on the list.

The information processing apparatus may further include a GUI display control section configured to control display of a graphical user interface (GUI) that specifies a program on the basis of the program listing displayed on the display unit.

The information processing apparatus may further include a schedule setup instruction section configured to instruct the content processing apparatus to set up a schedule for recording or viewing the program specified by the GUI.

The information processing apparatus may be integrated with a mobile phone so as to communicate with the content processing apparatus using a communication function of the mobile phone.

According to another embodiment of the present invention, there is provided a method for processing information through an information processing apparatus that communicates with a content processing apparatus for executing a process related to recording or playback of content and has a display unit for displaying information. The method includes the steps of: acquiring schedule information regarding a recording and/or viewing schedule set up in the content processing apparatus; acquiring result information regarding the result of recording performed in accordance with the schedule information set up in the content processing apparatus; and displaying the acquired schedule information or result information in a predetermined form on the display unit.

According to another embodiment of the present invention, there is provided a computer-readable program that allows an information processing apparatus to process information, the information processing apparatus communicating with a content processing apparatus for executing a process related to recording or playback of content and having a display unit for displaying information. The program includes the steps of: controlling acquisition of schedule information regarding a recording and/or viewing schedule set up in the content processing apparatus; controlling acquisition of result information regarding the result of recording performed in accordance with the schedule information set up in the content processing apparatus; and controlling display of the acquired schedule information or result information in a predetermined form on the display unit.

According to this embodiment, schedule information regarding a recording and/or viewing schedule set up in the content processing apparatus is acquired, result information regarding the result of recording performed in accordance with the schedule information set up in the content processing apparatus is acquired, and the acquired schedule information or result information is displayed in a predetermined form on the display unit.

According to another embodiment of the present invention, there is provided a content processing apparatus that performs a process related to recording or playback of content and communicates with an information processing apparatus. The content processing apparatus includes the following elements: A schedule setup section sets up a schedule for recording or playback of the content on the basis of information transmitted from the information processing apparatus. A schedule-information storage section stores information regarding the schedule set up by the schedule setup section. A schedule execution section executes a recording or playback process corresponding to the schedule on the basis of the information stored in the schedule-information storage section. A result determination section determines whether the recording process executed by the schedule execution section has succeeded. The information stored in the schedule-information storage section is transmitted to the information processing apparatus in response to a request transmitted from the information processing apparatus. Information regarding the result of recording determined by the result determination section is transmitted to the information processing apparatus in response to a request transmitted from the information processing apparatus.

According to another embodiment of the present invention, there is provided a method for processing content through a content processing apparatus that performs a process related to recording or playback of content and communicates with an information processing apparatus. The method includes the steps of: setting up a schedule for recording or playback of the content on the basis of information transmitted from the information processing apparatus; storing information regarding the schedule; transmitting the stored information regarding the schedule to the information processing apparatus in response to a request transmitted from the information processing apparatus; and transmitting information regarding the result of recording to the information processing apparatus in response to a request transmitted from the information processing apparatus. The information regarding the result of recording indicates whether the recording executed on the basis of the stored information regarding the schedule has succeeded.

According to this embodiment, a schedule for recording or playback of the content is set up on the basis of information transmitted from the information processing apparatus, information regarding the schedule is stored, the stored information regarding the schedule is transmitted to the information processing apparatus in response to a request transmitted from the information processing apparatus, and information regarding the result of recording, i.e., information indicating whether the recording executed on the basis of the stored information regarding the schedule has succeeded is transmitted to the information processing apparatus in response to a request transmitted from the information processing apparatus.

According to the present invention, schedule information regarding a recording schedule can be provided to a user who is viewing a program in a more understandable way. Furthermore, information for provision of the easily understandable schedule information can be provided.

### BRIEF DESCRIPTION OF THE DRAWINGS

FIG. 1 is a block diagram of the structure of a recording programming system according to an embodiment of the present invention;

FIG. 2 is a block diagram of the internal structure of a mobile terminal in FIG. 1;

FIG. 3 is a block diagram showing the functional structure of the mobile terminal, that of a recorder, and that of a program information server in FIG. 1;

FIG. 4 is a flowchart illustrating a process of acquiring program information;

FIG. 5 is a flowchart illustrating a process of transmitting the program information;

FIG. 6 is a flowchart illustrating a process of displaying the program information;

FIG. 7 is a flowchart illustrating a process of displaying the program information on a screen;

FIG. 8 is a flowchart illustrating a process for general display;

FIG. 9 shows an example of a general display screen;

FIG. 10 is a flowchart illustrating a process for list display;

FIG. 11 shows an example of a list display screen;

FIG. 12 is a flowchart illustrating a schedule setup process;

FIG. 13 is a flowchart showing a process by the recorder; and

FIG. 14 is a block diagram of the structure of a personal computer.

### DESCRIPTION OF THE PREFERRED EMBODIMENTS

Before describing an embodiment of the present invention, the correspondence between the features of the claims of the present invention and the specific elements disclosed in the specification or drawings is discussed below. This description is intended to assure that embodiments supporting the claimed invention are described in the specification or drawings. Thus, even if an element in the specification or drawings is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

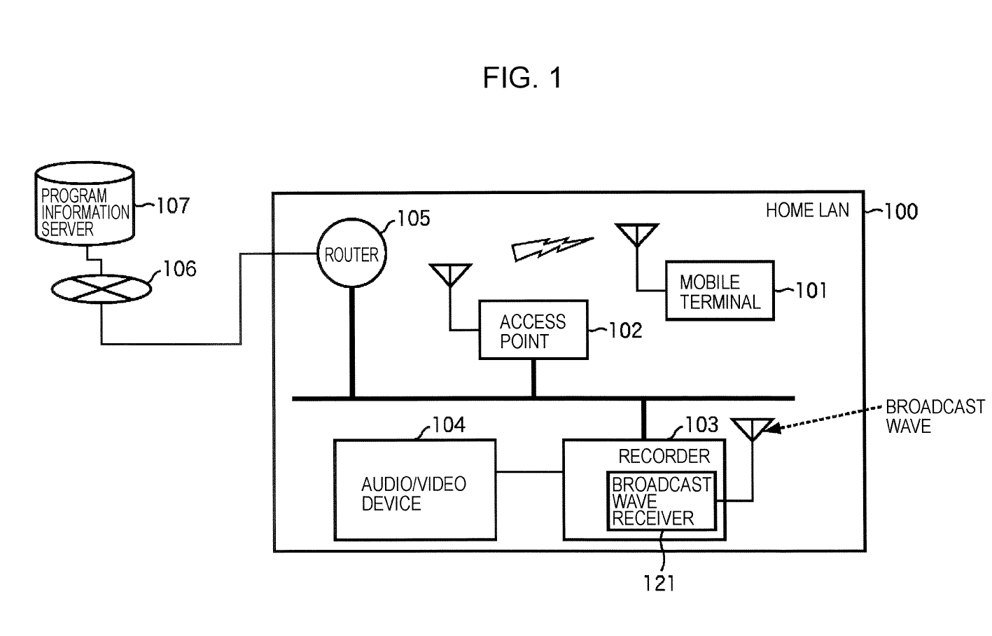

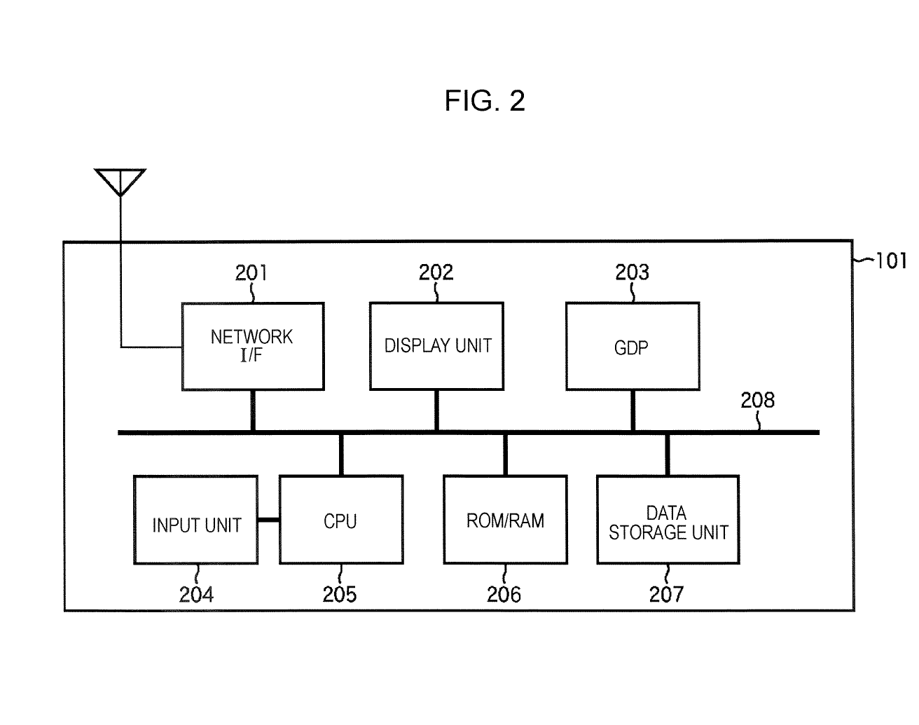

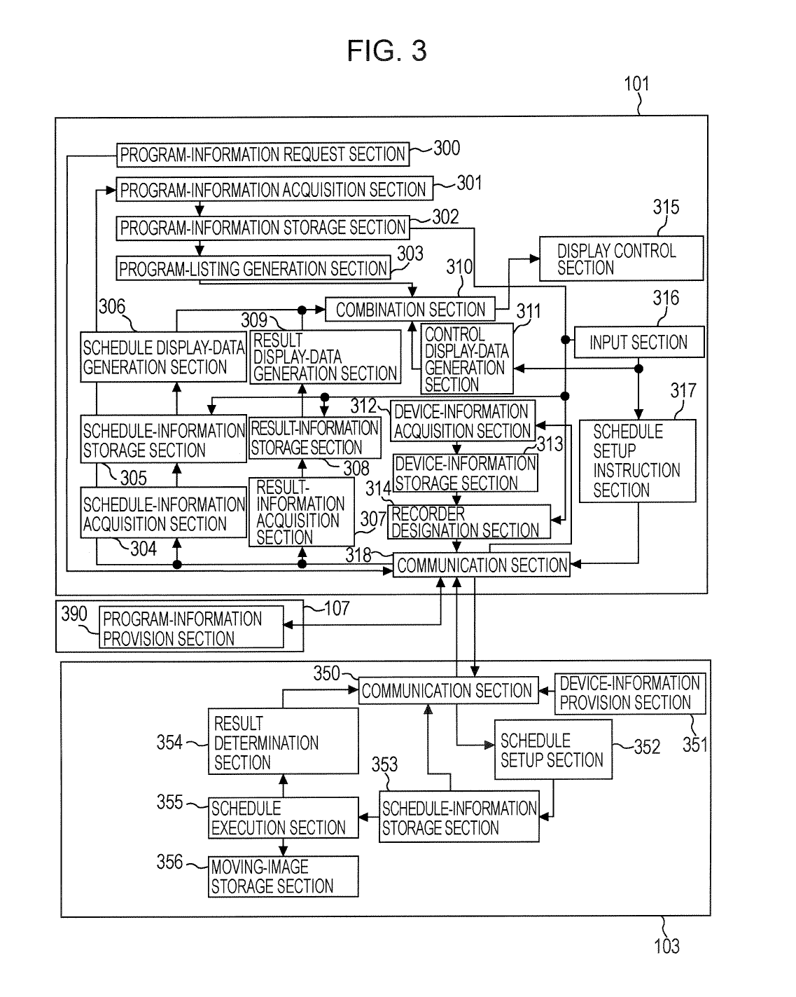

According to an embodiment of the present invention, there is provided an information processing apparatus (e.g., an mobile terminal 101 in FIG. 1) that communicates with a content processing apparatus (e.g., a recorder 103 in FIG. 1) for executing a process related to recording or playback of content and has a display unit (e.g., a display unit 202 in FIG. 2) for displaying information. The information processing apparatus includes the following elements: Schedule-information acquisition means (e.g., a schedule-information acquisition section 304 in FIG. 3) acquires schedule information regarding a recording and/or viewing schedule set up in the content processing apparatus. Result-information acquisition means (e.g., a result-information acquisition section 307 in FIG. 3) acquires result information regarding the result of recording performed in accordance with the schedule information set up in the content processing apparatus. Display means (e.g., a schedule display-data generation section 306, a result display-data generation section 309, and a combination section 310 in FIG. 3) displays the schedule information acquired by the schedule-information acquisition means or the result information acquired by the result-information acquisition means in a predetermined form on the display unit.

The content includes programs for broadcast. The information processing apparatus may further includes the following elements: Program-information acquisition means (e.g., a program-information acquisition section 301 in FIG. 3) acquires program information regarding the programs from an information management device (e.g., a program information server 107 in FIG. 1) connected via a network. Program-listing generation means (e.g., a program-listing generation section 303 in FIG. 3) generates display data for a program listing on the basis of the program information acquired by the program-information acquisition means.

The information processing apparatus may further include GUI display control means (e.g., a control display-data generation section 311 in FIG. 3) configured to control display of a graphical user interface (GUI) that specifies a program on the basis of the program listing displayed on the display unit.

The information processing apparatus may further include schedule setup instruction means (e.g., a schedule setup instruction section 317 in FIG. 3) configured to instruct the content processing apparatus to set up a schedule for recording or viewing the program specified by the GUI.

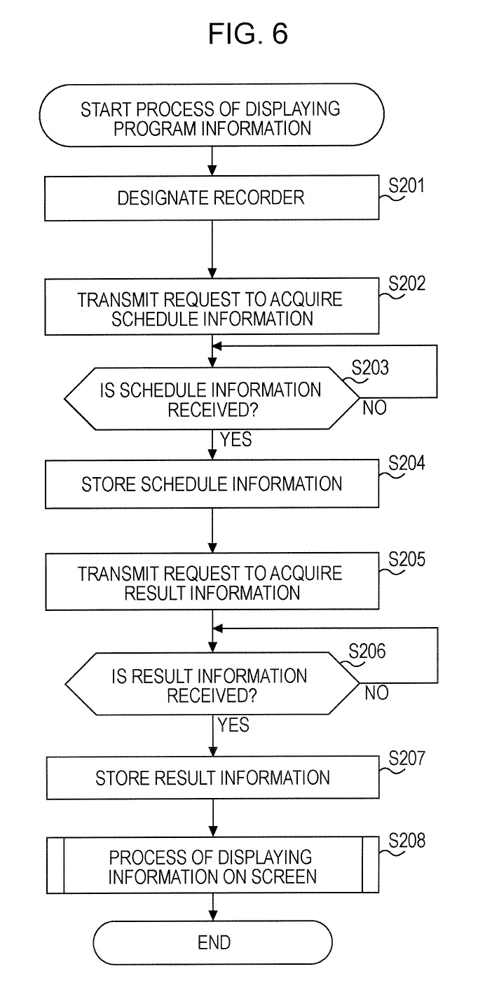

According to another embodiment of the present invention, there is provided a method for processing information through an information processing apparatus (e.g., the mobile terminal 101 in FIG. 1) that communicates with a content processing apparatus (e.g., the recorder 103 in FIG. 1) for executing a process related to recording or playback of content and has a display unit (e.g., the display unit 202 in FIG. 2) for displaying information. The method includes the steps of: acquiring schedule information regarding a recording and/or viewing schedule set up in the content processing apparatus (in, for example, steps S202 and S203 in FIG. 6); acquiring result information regarding the result of recording performed in accordance with the schedule information set up in the content processing apparatus (in, for example, steps S205 and S206 in FIG. 6); and displaying the acquired schedule information or result information in a predetermined form on the display unit (in, for example, step S208 in FIG. 6).

According to further another embodiment of the present invention, there is provided a content processing apparatus (e.g., the recorder 103 in FIG. 1) that performs a process related to recording or playback of content and communicates with an information processing apparatus (e.g., the mobile terminal 101 in FIG. 1). The content processing apparatus includes the following elements: Schedule setup means (e.g., a schedule setup section 352 in FIG. 3) sets up a schedule for recording or playback of the content on the basis of information transmitted from the information processing apparatus. Schedule-information storage means (e.g., a schedule-information storage section 353 in FIG. 3) stores information regarding the schedule set up by the schedule setup means. Schedule execution means (e.g., a schedule execution section 355 in FIG. 3) executes a recording or playback process corresponding to the schedule on the basis of the information stored in the schedule-information storage means. Result determination means (e.g., a result determination section 354 in FIG. 3) determines whether the recording process executed by the schedule execution means has succeeded. The information stored in the schedule-information storage section is transmitted to the information processing apparatus in response to a request transmitted from the information processing apparatus. Information regarding the result of recording determined by the result determination section is transmitted to the information processing apparatus in response to a request transmitted from the information processing apparatus.

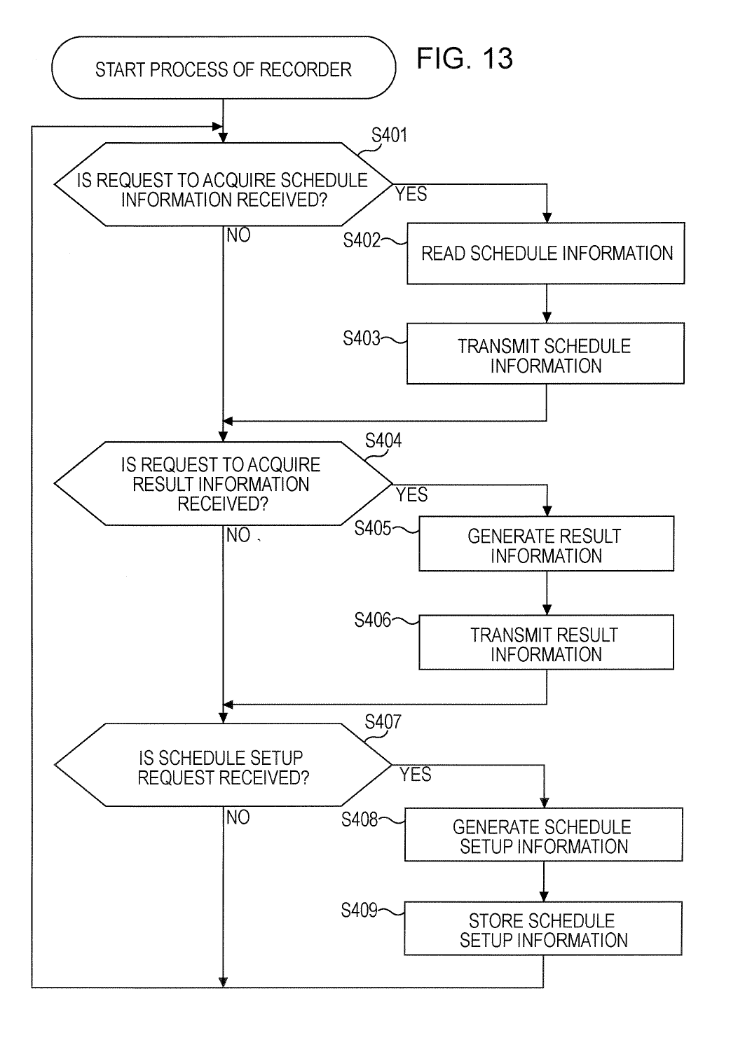

According to another embodiment of the present invention, there is provided a method for processing content through a content processing apparatus (e.g., the recorder 103 in FIG. 1) that performs a process related to recording or playback of content and communicates with an information processing apparatus (e.g., the mobile terminal 101 in FIG. 1). The method includes the steps of: setting up a schedule for recording or playback of the content on the basis of information transmitted from the information processing apparatus (in, for example, step S408 in FIG. 13); storing information regarding the schedule (in, for example, step S409 in FIG. 13); transmitting the stored information regarding the schedule to the information processing apparatus in response to a request transmitted from the information processing apparatus (in, for example, step S403 in FIG. 13); and transmitting information regarding the result of recording to the information processing apparatus in response to a request transmitted from the information processing apparatus (in, for example, step S406 in FIG. 13). The information regarding the result of recording indicates whether the recording executed on the basis of the stored information regarding the schedule has succeeded.

Embodiments of the present invention will now be described with reference to the drawings.

FIG. 1 is a block diagram of a recording programming system according to an embodiment of the present invention.

Referring to FIG. 1, a home local area network (LAN) 100 including wired and wireless networks is constructed in, for example, a user's home. A recorder 103, an access point 102, a mobile terminal 101, and a router 105 are connected to the home LAN 100.

The recorder 103 functions as, for example, a digital versatile disc (DVD) recorder or a hard disk drive (HDD) recorder. The recorder 103 includes a broadcast wave receiver 121 for receiving a broadcast wave, such as television broadcast signals, through an antenna. The recorder 103 records content, e.g. a television broadcast program, received through the broadcast wave receiver 121 onto a recording medium, such as a DVD or an HDD, on the basis of an instruction from the user.

The recorder 103 is connected to an audio/video device 104 serving as, for example, a television receiver. A piece of content recorded by the recorder 103 is played on the basis of, for example, an instruction from the user. A video image in the piece of content is displayed on the audio/video device 104 while the corresponding audio is output. The recorder 103 and the audio/video device 104 may be combined in one unit.

The access point 102 is a device that links wireless devices connected via the wireless network of the home LAN 100 to the wired network of the home LAN 100. The access point 102 transmits and receives predetermined-frequency signals to communicate with the mobile terminal 101.

The mobile terminal 101 serves as, for example, a remote control (remote commander) for transmitting various commands to the recorder 103. The mobile terminal 101 communicates with the recorder 103 through the access point 102. The mobile terminal 101 has an operation input unit including buttons and a dial and a display unit, such as a liquid crystal display (LCD). The mobile terminal 101 is used to program the recorder 103 to record a program (i.e., to set up a schedule for recording a program in the recorder 103) as necessary. Furthermore, the mobile terminal 101 provides information regarding a recording schedule set up in the recorder 103 to the user. In this specification, “information regarding a recording (and/or viewing) schedule” will be called “schedule information” hereinafter.

The user holding the mobile terminal 101 can access the home LAN 100 in any location in the user's home and instruct the recorder 103 to execute any of various processes.

The devices connected to the home LAN 100 are connected to the Internet 106 via the router 105. A program information server 107 for storing program information, such as Electronic Program Guide (EPG), regarding programs to be broadcast and distributing the program information as necessary is connected to the Internet 106. In other words, the mobile terminal 101 can obtain the program information from the program information server 107 as necessary.

Programs associated with the program information obtained from the program information server 107 and those recorded (or viewed) through the recorder 103 are not limited to broadcast programs. For example, content distributed over a network, such as the Internet 106, may be included.

FIG. 2 is a block diagram of the internal structure of the mobile terminal 101.

Referring to FIG. 2, the mobile terminal 101 includes a network interface (I/F) 201, a display unit 202, such as an LCD, and a graphic display processor (GDP) 203. The network I/F 201 includes a wireless LAN adapter and communicates with the access point 102. The display unit 202 displays the program information, the schedule information, and various graphical user interfaces (GUIs). The GDP 203 controls the display unit 202 to display an image.

The mobile terminal 101 further includes a CPU 205, a ROM/RAM 206, and a data storage unit 207. The CPU 205 executes various processes of the mobile terminal 101 on the basis of software, such as a program. The ROM stores the program and the RAM is used to load and execute the program. The data storage unit 207 stores the program information and the schedule information. The components of the mobile terminal 101 are connected to each other via a bus 208. The mobile terminal 101 further has an input unit 204, including buttons and a dial, through which the user operates the GUIs.

FIG. 3 is a block diagram illustrating the functional structure of the mobile terminal 101, that of the recorder 103, and that of the program information server 107.

In the mobile terminal 101, after startup, a program-information request section 300 transmits a request to acquire the program information through a communication section 318 to the program information server 107 at predetermined intervals preset during, for example, normal operation or on the basis of an instruction from the user.

In the program information server 107, a program-information provision section 390 transmits, i.e., provides the program information to the mobile terminal 101 over the Internet 106 in response to the received request.

In the mobile terminal 101, a program-information acquisition section 301 acquires the program information transmitted from the program information server 107 through the communication section 318. A program-information storage section 302 stores the acquired information.

For example, when the user demands to display a program listing through an input section 316 (i.e., using the input unit 204) while viewing a screen, displayed under the control of a display control section 315, on the display unit 202, a program-listing generation section 303 generates display data on the basis of the program information stored by the program-information storage section 302. A combination section 310 processes the generated display data and the display control section 315 controls the resultant data such that the program listing is displayed on the screen.

In the above description, it is assumed that the program-information storage section 302 stores the program information in a recording medium. The recording medium may be designed as a removable medium that is removable from the mobile terminal 101 like a memory card. The memory card, which stores the program information, may be attached to another mobile terminal or a device capable of reading the program information. The device may display the program information or set up a recording schedule, which will be described later.

When the mobile terminal 101 and the recorder 103 are connected to the home LAN 100, a device-information provision section 351 included in the recorder 103 transmits device information concerning the recorder 103. The device information includes unique information (e.g., the ID of the recorder 103) whereby the recorder 103 can be specified on the network. In the mobile terminal 101, a device-information acquisition section 312 receives the device information transmitted from the recorder 103 through the communication section 318 and a device-information storage section 313 stores the acquired device information.

For example, when the user sets up a recording (or viewing) schedule using the recorder 103 and the audio/video device 104 by operating the recorder 103 and the GUI therefor, the user can confirm schedule information using the mobile terminal 101.

After the recording (or viewing) schedule is set up in the recorder 103, a schedule-information storage section 353 stores schedule information regarding the recording (or viewing) schedule.

To confirm the schedule information set up in the recorder 103, a recorder designation section 314 in the mobile terminal 101 designates the recorder 103 on the basis of the device information regarding the recorder 103 stored by the device-information storage section 313. A request to acquire the schedule information is transmitted from the mobile terminal 101 to the designated recorder 103.

In the recorder 103, the schedule information is read from the schedule-information storage section 353 and is transmitted to the mobile terminal 101 through a communication section 350. In the mobile terminal 101, a schedule-information acquisition section 304 receives the schedule information and a schedule-information storage section 305 stores the received information.

When the schedule information is read from the schedule-information storage section 305 in accordance with an instruction from the user, a schedule display-data generation section 306 generates display data for the schedule information, the combination section 310 processes the generated data, and the display control section 315 controls the resultant data such that information regarding the recording (or viewing) schedule is displayed on the screen.

In the recorder 103, a schedule execution section 355 executes a scheduled recording on the basis of the schedule information. A moving-image storage section 356 stores data on a recording medium, such as a DVD or an HDD. The user can confirm information regarding the result of recording by the recorder 103 using the mobile terminal 101. In this specification, “information regarding the result of recording” will be called “result information” hereinafter.

To confirm the result information, the recorder designation section 314 designates the recorder 103 on the basis of the device information related to the recorder 103 stored by the device-information storage section 313 of the mobile terminal 101. A request to acquire the result information is transmitted from the mobile terminal 101 to the recorder 103.

In the recorder 103, a result determination section 354 determines whether the recording has succeeded or failed. Information indicating the result of recording based on the determination, i.e., the result information is transmitted to the mobile terminal 101 through the communication section 350. In the mobile terminal 101, a result-information acquisition section 307 receives the result information and a result-information storage section 308 stores the received information.

When the result information stored by the result-information storage section 308 is read in accordance with an instruction from the user, a result display-data generation section 309 generates display data for the result information, the combination section 310 processes the generated data, and the display control section 315 controls the resultant data such that information regarding the result of recording is displayed on the screen.

A control display-data generation section 311 generates display data for various GUIs, used for setup of a recording schedule in the recorder 103 using the mobile terminal 101, on the basis of, for example, an input through the input section 316. The combination section 310 processes the generated data. The display control section 315 controls the resultant data such that the GUIs are displayed on the screen.

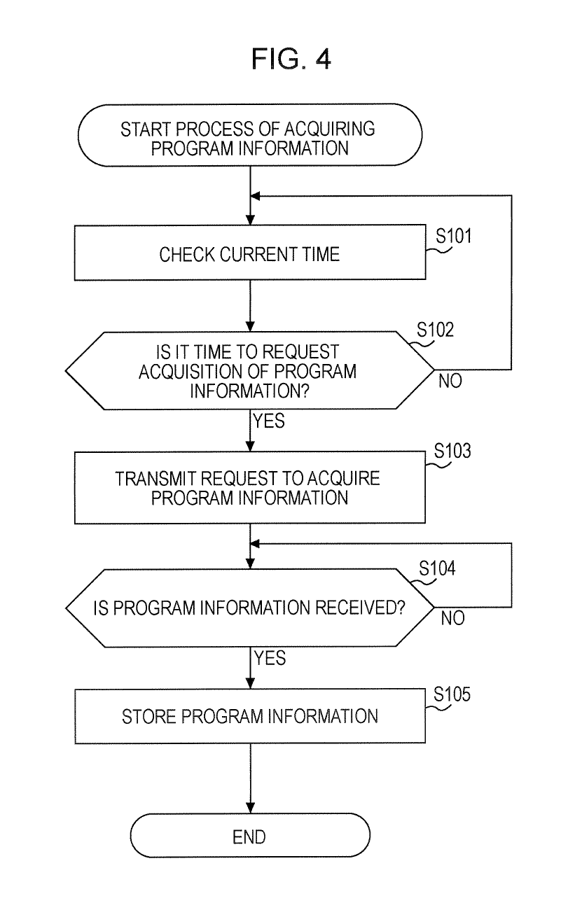

A process of acquiring program information by the mobile terminal 101 will now be described with reference to a flowchart of FIG. 4.

In step S101, the program-information request section 300 refers to information output from a timer (not shown) built in the mobile terminal 101 to check the current time.

In step S102, the program-information request section 300 determines whether the current time is an appropriate time to acquire the program information. If NO, the process is returned to step S101.

As described above, after startup, the mobile terminal 101 transmits a request to acquire the program information at predetermined intervals preset during, for example, the normal operation. For instance, after a lapse of a predetermined time preset during the normal operation, it is determined in step S102 that the current time is an appropriate time to acquire the program information. The process proceeds to step S103. Alternatively, if an instruction from the user is given irrespective of the passage of time, it may be determined in step S102 that the current time is an appropriate time to acquire the program information.

In step S103, the program-information request section 300 transmits a request to acquire the program information to the program information server 107 through the communication section 318. This request is information indicating that the mobile terminal 101 requests the program information and includes, for example, a message prompting the program information server 107 to transmit the program information and the address or ID specifying the mobile terminal 101.

In step S104, the program-information acquisition section 301 determines whether the program information is received from the program information server 107, the information being transmitted in response to the request transmitted in step S103. The program-information acquisition section 301 stands by until it is determined that the program information is received. If YES in step S104, the process proceeds to step S105.

In step S105, the program-information storage section 302 stores the received program information in a predetermined area in, for example, the data storage unit 207.

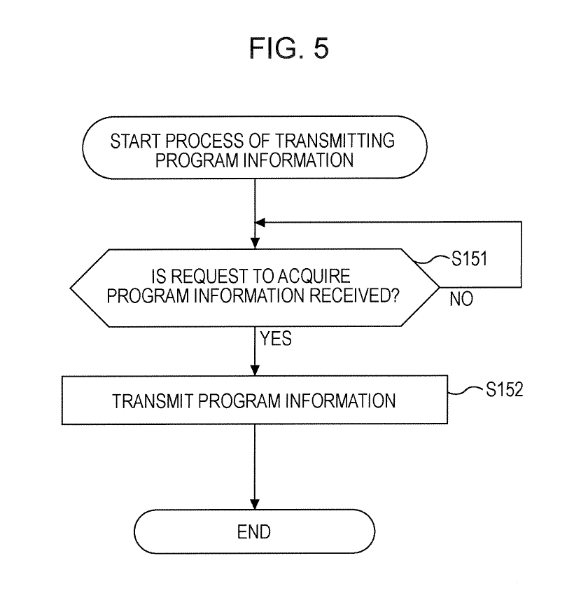

A process of transmitting program information by the program information server 107 will now be described with reference to a flowchart of FIG. 5, the process being executed synchronously with the process of acquiring the program information by the mobile terminal 101.

In step S151, the program-information provision section 390 determines whether a request to acquire the program information is received. The program-information provision section 390 stands by until it is determined that the request is received. When the program information server 107 receives the request which is transmitted from the mobile terminal 101 in step S103 of FIG. 4, it is determined in step S151 that the request is received. The process proceeds to step S152.

In step S152, the program-information provision section 390 transmits the program information to the mobile terminal 101. Thus, the mobile terminal 101 receives the program information through the Internet 106, the router 105, and the access point 102. Then, the above-described steps S104 and S105 in FIG. 4 are executed.

As described above, the mobile terminal 101 acquires the program information from the program information server 107.

A process of displaying program information by the mobile terminal 101 will now be described with reference to a flowchart of FIG. 6.

In step S201, the recorder designation section 314 designates a recorder. As described above, the device-information provision section 351 in the recorder 103 connected to the home LAN 100 transmits the device information related to the recorder 103 to the mobile terminal 101. Since the device information includes the ID of the recorder 103, the recorder 103 can be specified in the home LAN 100 using its ID. In the mobile terminal 101, the device-information acquisition section 312 receives the device information transmitted from the recorder 103 and the device-information storage section 313 stores the received information. In step S201, the recorder designation section 314 designates the recorder 103 on the basis of the device information related to the recorder 103 stored by the device-information storage section 313.

In step S202, a request to acquire schedule information is transmitted from the mobile terminal 101 through the communication section 318 to the recorder 103 designated in step S201. This request is information indicating that the mobile terminal 101 requests the schedule information and includes, for example, a message prompting the recorder 103 to transmit the schedule information and the address or ID specifying the mobile terminal 101.

In step S203, the schedule-information acquisition section 304 determines whether the schedule information is received from the recorder 103, the information being transmitted from the recorder 103 in response to the request transmitted in step S202. The schedule-information acquisition section 304 stands by until it is determined that the schedule information is received.

If YES in step S203, the process proceeds to step S204. The schedule-information storage section 305 stores the received information in a predetermined area in, for example, the data storage unit 207.

In step S205, a request to acquire result information is transmitted from the mobile terminal 101 through the communication section 318 to the recorder 103 designated in step S201. This request is information indicating that the mobile terminal 101 requests the result information and includes, for example, a message prompting the recorder 103 to transmit the result information and the address or ID specifying the mobile terminal 101.

In step S206, the result-information acquisition section 307 determines whether the result information is received from the recorder 103, the information being transmitted from the recorder 103 in response to the request transmitted in step S205. The result-information acquisition section 307 stands by until it is determined that the result information is received.

If YES in step S206, the process proceeds to step S207. The result-information storage section 308 stores the received result information in a predetermined area in, for example, the data storage unit 207.

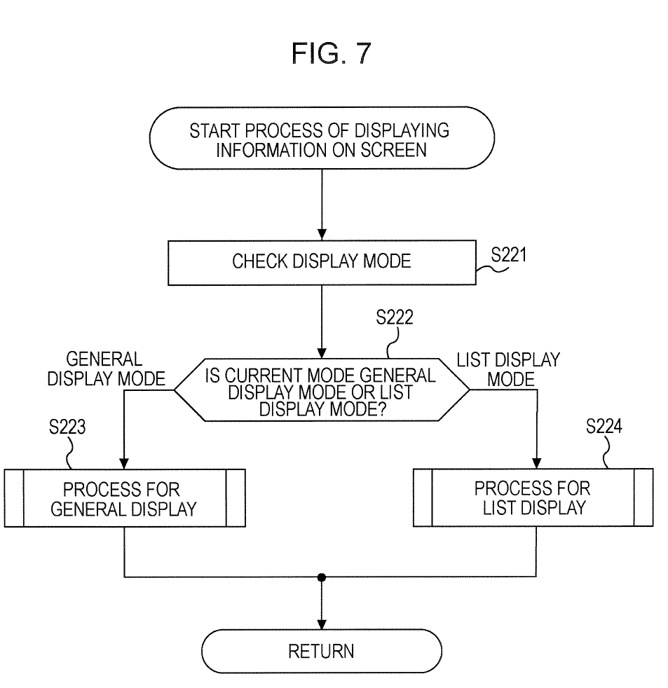

In step S208, a process, which will be described below with reference to FIG. 7, of displaying information on the screen is executed. Consequently, the display unit 202 of the mobile terminal 101 displays the program information, the schedule information, and the result information.

The process in step S208 of FIG. 6 will now be described in detail with reference to a flowchart of FIG. 7.

In step S221, the combination section 310 checks a display mode. In this instance, each display mode specifies a way of displaying the program information obtained from the program information server 107 and the schedule information and the result information obtained from the recorder 103. The display modes include a general display mode and a list display mode. In the general display mode, the program information, the schedule information, and the result information are displayed. In the list display mode, the schedule information and the result information are displayed as a list independent of the program information.

In step S222, the combination section 310 determines whether the checked display mode is the general display mode or the list display mode. It is assumed that the display mode is preset (previously selected) prior to the process in accordance with an instruction from the user.

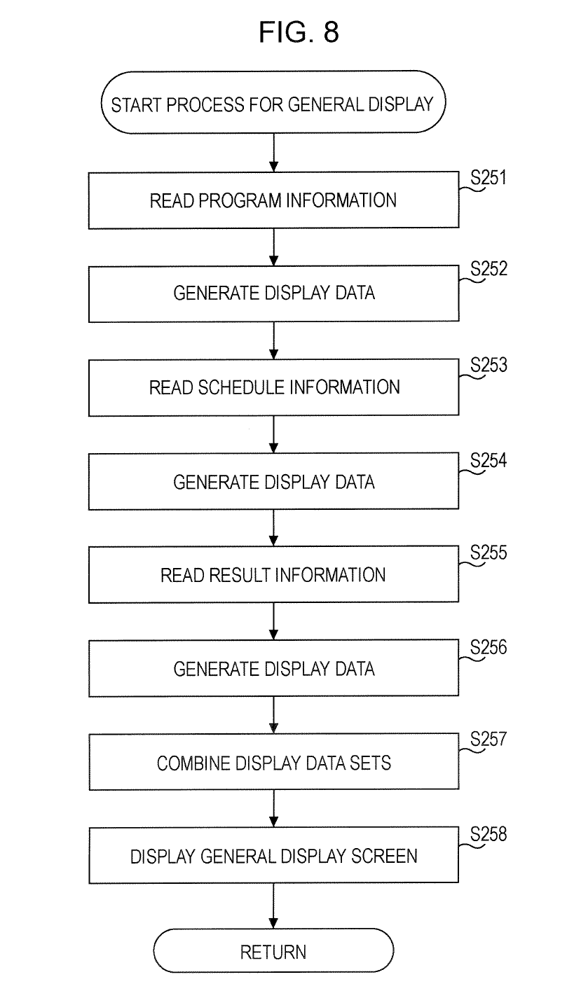

When it is determined in step S222 that it is the general display mode, the process proceeds to step S223. A process for general display is executed. This process will be described below with reference to FIG. 8.

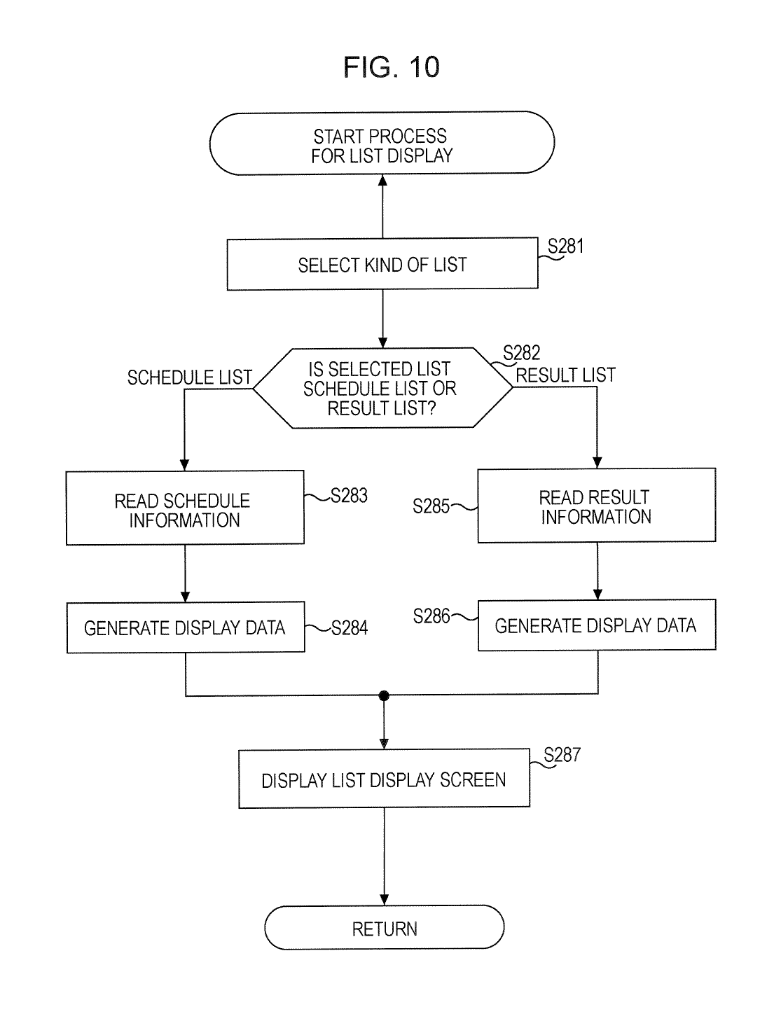

On the other hand, if it is determined in step S222 that it is the list display mode, the process proceeds to step S224. A process for list display is executed. This process will be described later with reference to FIG. 10.

The process for general display in step S223 of FIG. 7 will now be described in detail with reference to a flowchart of FIG. 8.

In step S251, the program-information storage section 302 reads the program information which is obtained from the program information server 107 and is stored.

In step S252, the program-listing generation section 303 generates display data relating to a program listing on the basis of the program information read in step S251. The generated display data is used to display the program listing based on the program information such that the abscissa represents channel number, the ordinate represents time, and programs are listed in display frames, serving as intersections of the channel number axis and the time axis.

In step S253, the schedule-information storage section 305 reads the schedule information which is obtained from the recorder 103 and is stored.

In step S254, the schedule display-data generation section 306 generates display data on the basis of the schedule information read in step S253. As will be described in detail below, the generated display data is used for display of the schedule information in the program listing related to the display data generated in step S252.

In step S255, the result-information storage section 308 reads the result information which is obtained from the recorder 103 and is stored.

In step S256, the result display-data generation section 309 generates display data on the basis of the result information read in step S255. As will be described in detail below, the generated display data is used for display of the result information in the program listing related to the display data generated in step S252.

In step S257, the combination section 310 combines three sets of the display data generated in steps S252, S254, and S256 into resultant display data.

In step S258, the display control section 315 displays an image based on the display data obtained in step S257 on the screen of the display unit 202, thus providing a general display screen.

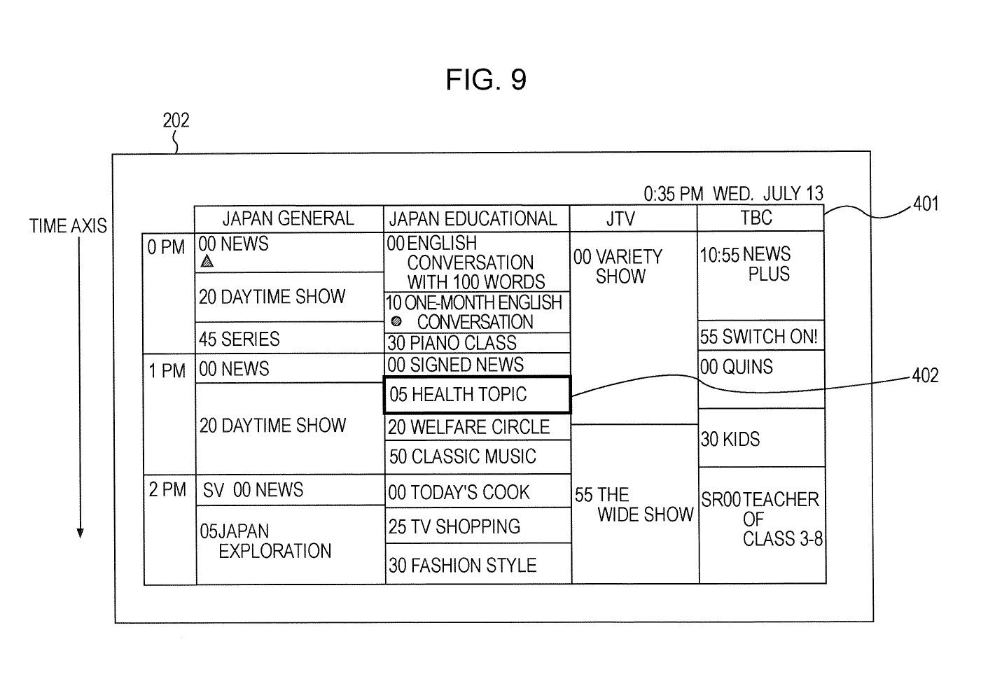

FIG. 9 shows an example of the general display screen. Referring to FIG. 9, the screen of the display unit 202 displays a program listing 401 in which the ordinate represents the time axis, the abscissa represents the channel number axis, and each display frame two-dimensionally specified by the time axis and the channel number axis includes information regarding a program, e.g., a title for the program, to be broadcast by the corresponding channel (i.e., broadcasting station) in a predetermined time slot. In this program listing, the current time is “0:35 PM WED. JULY 13”. FIG. 9 shows the program listing corresponding to a predetermined time period before and after the current time (in this case, the program listing from 0:00 to 3:00 PM).

In FIG. 9, the schedule information is also displayed in the program listing 401. Referring to FIG. 9, in the program listing 401, “SV” is displayed in a box (display frame) corresponding to a program “NEWS” to be broadcast by a channel named “JAPAN GENERAL” at 2:00 PM. In this specification, “SV” is an abbreviation for “SCHEDULED VIEWING” and indicates that a schedule for viewing this program is set up in the recorder 103. In addition, in the program listing 401, “SR” is displayed in a box (display frame) corresponding to a drama “TEACHER OF CLASS 3-8” to be aired by a channel named “TBC” at 2:00 PM. In this specification, “SR” is an abbreviation for “SCHEDULED RECORDING” and indicates that a schedule for recording this program is set up in the recorder 103.

In FIG. 9, the result information is also displayed in the program listing 401. In the program listing 401 of FIG. 9, a shaded triangle is displayed in a box (display frame) corresponding to a program “NEWS” to be broadcast by the channel “JAPAN GENERAL” at 0:00 PM. This mark means that the recorder 103 was programmed to record this program but the recording has partially failed because of, for example, insufficient capacity of a recording medium. In addition, a shaped circle is displayed in a box (display frame) corresponding to a program “ONE-MONTH ENGLISH CONVERSATION” aired by a channel “JAPAN EDUCATIONAL” at 0:10 PM. This mark means that the recorder 103 was programmed to record this program and the recording has succeeded.

Under the condition that the recorder 103 has a feature for automatically recording a program having a high degree of association with set keywords representing user preferences on the basis of the program information, characters or a mark representing that a schedule for recording (or viewing) a target program is automatically set up by this feature of the recorder 103 or is set up in accordance with an instruction from the user may be displayed in addition to the characters representing the above-described recording and viewing schedule and the marks representing the results of recording.

The display frame of a target program may be highlighted using color or luminance contrast instead of displaying of the characters or mark representing scheduled recording (or viewing) or the result of recording and the characters or mark representing that a schedule for recording (or viewing) the corresponding program is automatically set up by the above-described feature of the recorder 103 or is set up in accordance with an instruction from the user.

As described above, since the schedule information regarding a recording and viewing schedule and the result information regarding the result of recording are displayed together with the program listing 401, the user can readily and reliably know which program is scheduled to be recorded or viewed through the recorder 103 and whether the recording of each scheduled program has succeeded. In addition, since the program listing 401 with the schedule information and the result information is displayed on the display unit 202 of the mobile terminal 101, the user who is viewing content displayed on, for example, the audio/video device 104 can easily and reliably know which program is scheduled to be recorded or viewed through the recorder 103 and whether the recording of each schedule program has succeeded.

The case where the schedule information and the result information are displayed together with the program listing 401 has been described. Only the schedule information may be displayed together with the program listing 401. Alternatively, only the result information may be displayed together with the program listing 401. In addition, only the program listing 401 may be displayed as necessary.

The process for list display in step S224 of FIG. 7 will now be described in detail with reference to a flowchart of FIG. 10.

In step S281, the combination section 310 specifies the kind of list. In this instance, there are two kinds of lists, i.e., a schedule list regarding the recording and viewing schedule and a result list regarding the result of recording. Any one of the two lists is selected in accordance with, for example, an indication from the user.

In step S282, it is determined which of the schedule list and the result list is selected. If it is determined in step S282 that the schedule list is selected, the process proceeds to step S283.

In step S283, the schedule-information storage section 305 reads the schedule information which is obtained from the recorder 103 and is stored.

In step S284, the schedule display-data generation section 306 generates display data on the basis of the schedule information read in step S283. The generated display data used for display of the schedule information listed in, for example, time series is generated, as will be described in detail below.

On the other hand, if it is determined in step S282 that the result list is selected, the process proceeds to step S285.

In step S285, the result-information storage section 308 reads the result information which is obtained from the recorder 103 and is stored.

In step S286, the result display-data generation section 309 generates display data on the basis of the result information read in step S285. Thus, the display data used for display of the result information listed in, for example, time series is generated, as will be described in detail later.

After step S284 or S286, the process proceeds to step S287.

In step S287, the display control section 315 displays an image based on the display data generated in step S284 or S286 on the screen of the display unit 202, thus providing a list display screen.

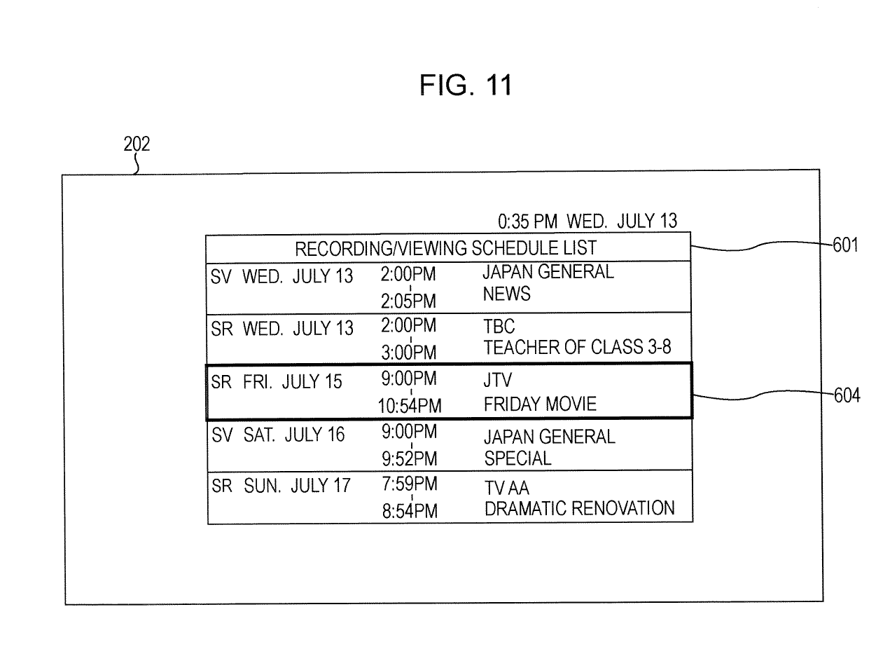

FIG. 11 shows an example of the list display screen. This example is obtained when it is determined in step S282 that the schedule list is selected. The schedule information is displayed such that programs related to the recording and viewing schedule are listed in time series.

Six display frames are arranged vertically in FIG. 11. In the top display frame in FIG. 11, “RECORDING/VIEWING SCHEDULE LIST” is displayed.

In FIG. 11, the second to sixth display frames from the top contain information regarding scheduled programs. The second display frame includes characters “SV”, “WED. JULY 13 2:00 PM-2:05 PM”, “JAPAN GENERAL”, and “NEWS”. This means that a schedule for viewing a program “NEWS” which is to be aired by the channel “JAPAN GENERAL” from 2:00 PM to 2:05 PM on Wednesday, July 13 is set up in the recorder 103.

The third display frame includes characters “SR”, “WED. July 13 2:00 PM-3:00 PM”, “TBC”, and “TEACHER OF CLASS 3-8”. This means that a schedule for recording a program “TEACHER OF CLASS 3-8” which is to be aired by the channel “TBC” from 2:00 PM to 3:00 PM on Wednesday, July 13 is set up in the recorder 103.

Similarly, the fourth to sixth display frames include characters related to respective scheduled programs.

Since the schedule information or the result information is listed as described above, the user can readily know which program is scheduled to be recorded or viewed through the recorder 103 and whether the recording of each scheduled program has succeeded. Advantageously, the user can obtain desired information more quickly with the list display screen than the general display screen in which the schedule information and the result information are displayed together with the program listing.

In addition, a list of scheduled programs or a list of the results of recording is displayed on the display unit 202 of the mobile terminal 101. Advantageously, the user who is watching content on, for example, the audio/video device 104 can readily and rapidly know which program is scheduled to be recorded or viewed through the recorder 103 and whether the recording of each scheduled program has succeeded.

The schedule information and the result information may be displayed in the same list.

Processes executed by the recorder 103 associated with the processes by the mobile terminal 101 explained with reference to FIGS. 6 to 11 will be described later.

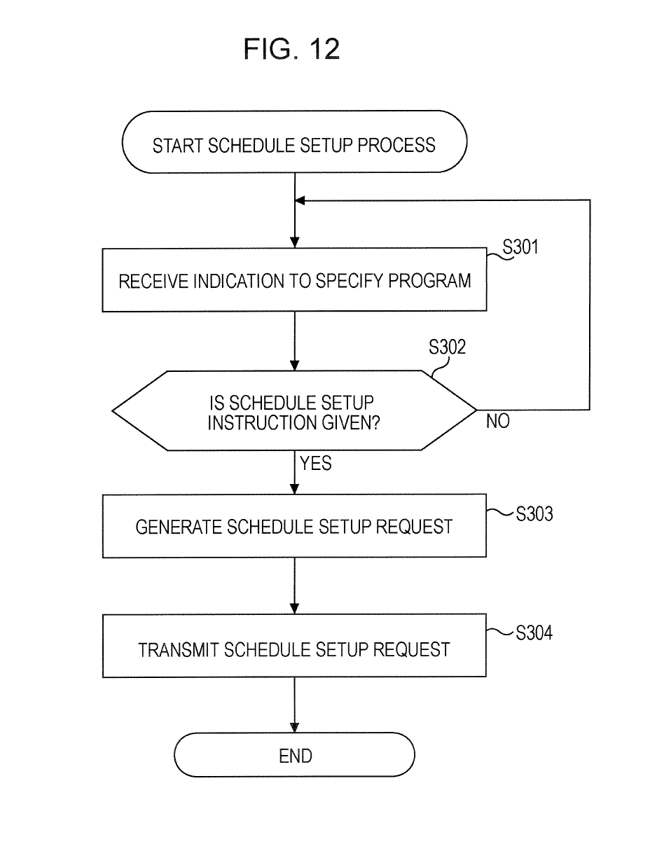

A process of setting up a schedule for recording or viewing in the recorder 103 through the mobile terminal 101 will now be described with reference to a flowchart of FIG. 12. This process is executed when, for example, the above-described program listing in FIG. 9 is displayed.

In step S301, a schedule setup instruction section 317 receives an indication to specify a program. A program is specified as follows.

For instance, each of a focus 402 displayed as a bold line in FIG. 9 and a focus 604 displayed as a bold line in FIG. 11 is one of GUIs generated by the control display-data generation section 311. In this state shown in FIG. 9, for example, when an operation to move the focus 402 to the left is performed in response to an operation input received through the input section 316, the focus 402 is moved from a program “HEALTH TOPIC” to another program “DAYTIME SHOW”. Thus, the user can specify a desired program from the program listing 401.

In step S302, the schedule setup instruction section 317 determines whether a schedule setup instruction to set up a schedule for recording (or viewing) the specified program is given. If it is determined that any schedule setup instruction is not given, the process is returned to step S301. For example, when the user presses the “recording program” button (not shown) on the input unit 204 of the mobile terminal 101, it is determined in step S302 that a schedule setup instruction to set up a schedule for recording a program specified by the focus 402 is given. The “recording program” button (and a “viewing program” button) may be omitted and only one “program” button may be arranged. In this case, when the user presses the “program” button, GUIs used for selection between recording and viewing are displayed, prompting the user to select one of them. In step S302, the determination may be made in accordance with the selection.

If it is determined in step S302 that a schedule setup instruction to set up a schedule for recording (or viewing) is given, the process proceeds to step S303.

In step S303, the schedule setup instruction section 317 generates a schedule setup request corresponding to the schedule setup instruction for recording (or viewing) received in step S302. The schedule setup request is information including the air date, start time, and stop time of the program to be recorded (or viewed), and the channel on which the program is to be broadcast.

In step S304, the schedule setup instruction section 317 transmits the schedule setup request generated in step S303 to the recorder 103 through the communication section 318. The recorder 103 receives this request, so that a schedule for recording (or viewing) is set up in the recorder 103.

As described above, the recording or viewing schedule is set up. The user can set up a schedule for recording or viewing a desired program simply by moving the focus on the program listing onto the desired program and pressing the “program” button. Accordingly, the user can easily and reliably set up the schedule for recording or viewing the desired program. Since the program listing 401 is displayed on the display unit 202 of the mobile terminal 101, the user who is viewing content on the audio/video device 104 can readily and reliably set up a schedule for recording or viewing a desired program.

A process executed by the recorder 103 associated with the processes by the mobile terminal 101 discussed with reference to FIGS. 6 through 12 will now be described with reference to a flowchart of FIG. 13.

In step S401, the communication section 350 determines whether a request to acquire schedule information is received. For example, when the recorder 103 receives the request to acquire the schedule information transmitted from the mobile terminal 101 in step S202 of FIG. 6, it is determined in step S401 that the request is received. The process proceeds to step S402.

In step S402, the schedule-information storage section 353 reads stored schedule information.

In step S403, the communication section 350 transmits the schedule information read in step S402 to the mobile terminal 101.

If it is determined in step S401 that any request to acquire the schedule information is not received, alternatively, after step S403, the process proceeds to step S404.

In step S404, the communication section 350 determines whether a request to acquire result information regarding the result of recording is received. For example, when the recorder 103 receives a request to acquire the result information transmitted from the mobile terminal 101 in step S205 of FIG. 6, it is determined in step S404 that the request to acquire the result information is received. The process proceeds to step S405.

In step S405, the result determination section 354 determines the result of recording executed by the recorder 103 and generates result information.

In step S406, the communication section 350 transmits the result information generated in step S405 to the mobile terminal 101.

If it is determined in step S404 that any request to acquire the result information is not received, alternatively, after step S406, the process proceeds to step S407.

In step S407, the communication section 350 determines whether a schedule setup request is received. For example, when the recorder 103 receives the schedule setup request transmitted from the mobile terminal 101 in step S304 of FIG. 12, it is determined in step S407 that the schedule setup request is received. The process proceeds to step S408.

In step S408, a schedule setup section 352 generates schedule setup information on the basis of the schedule setup request received in step S407. The generated schedule setup information includes the air date, start time, and stop time of a program to be recorded (or viewed) and the channel on which the program is to be aired, and a command to cause the recorder 103 to record the program or enable viewing of the program.

In step S409, the schedule-information storage section 353 stores the schedule setup information generated in step S408. Thus, the schedule execution section 355 executes the scheduled recording or viewing of the program aired on the programmed channel at the programmed time. The moving-image storage section 356 stores the recorded program.

If it is determined in step S407 that any schedule setup request is not received, alternatively, after step S409, the process is returned to step S401. Steps S401 and subsequent steps are repeated.

As described above, the process by the recorder 103 is executed in association with the processes by the mobile terminal 101.

The case where the mobile terminal 101 serves as a remote control has been described. For example, the mobile terminal 101 may be integrated with an electronic device, such as a portable game machine, having a display that is wide enough to provide a program listing to the user.

Alternatively, the mobile terminal 101 may be integrated with, for example, a mobile phone. In this case, the mobile terminal 101 may be connected to the Internet 106 via a base station of a mobile phone company so as to communicate with the recorder 103 on the home LAN 100 through the router 105.

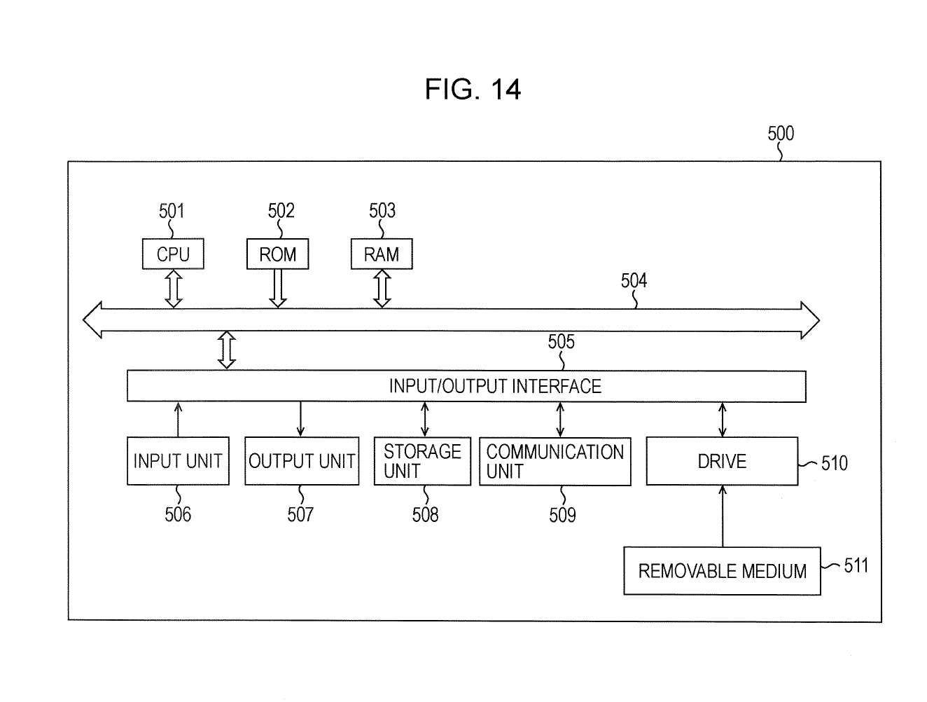

The above-described series of processes can be executed by hardware or software. When the series of processes is executed by software, a program constituting the software is installed through a network or a recording medium into a computer incorporated in dedicated hardware or into a multi-purpose personal computer 500, shown in FIG. 14, capable of executing various functions by installing various programs thereto.

Referring to FIG. 14, a central processing unit (CPU) 501 executes various processes in accordance with a program stored in a read only memory (ROM) 502 or a program loaded from a storage unit 508 to a random access memory (RAM) 503. The RAM 503 also stores data necessary for the CPU 501 to execute the various processes as appropriate.

The CPU 501, the ROM 502, and the RAM 503 are connected to each other via a bus 504. An input-output interface 505 is connected to the bus 504.

An input unit 506, an output unit 507, the storage unit 508, and a communication unit 509 are connected to the input-output interface 505. The input unit 506 includes a keyboard and a mouse. The output unit 507 includes a display, such as a cathode ray tube (CRT) or a liquid crystal display (LCD), and a speaker. The storage unit 508 includes a hard disk. The communication unit 509 includes a modem and a network interface card, such as a LAN card. The communication unit 509 executes communication processing over a network including the Internet.

A drive 510 is connected to the input-output interface 505 as necessary. A removable medium 511, such as a magnetic disk, an optical disk, a magneto-optical disk, or a semiconductor memory, is loaded into the drive 510 as appropriate. A computer program read out from the medium is installed on the storage unit 508 as necessary.

When the above-described series of processes is executed by software, a program constituting the software is installed on the computer 500 through a network, such as the Internet, or a recording medium including the removable medium 511.

The recording medium includes not only the removable medium 511, such as a magnetic disk (including a flexible disk), an optical disk (e.g., a compact disk-read only memory (CD-ROM) or a digital versatile disk (DVD)), a magneto-optical disk (including a MiniDisc (MD)), or a semiconductor memory, in which the program has been recorded and which is distributed in order to provide the program to a user but also the ROM 502 and the hard disk included in the storage unit 508, in each of which the program has been recorded and which is then delivered to the user.

In this specification, steps executing the above-described series of processes may be performed in time series in the described order, or may be performed in parallel or individually.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus that communicates with a content processing apparatus for executing a process related to recording or playback of content and has a display unit for displaying information, the information processing apparatus comprising:
schedule-information acquisition means for acquiring schedule information regarding a recording and/or viewing schedule set up in the content processing apparatus;
result-information acquisition means for acquiring result information regarding the result of recording performed in accordance with the schedule information set up in the content processing apparatus; and
display means for displaying the schedule information acquired by the schedule-information acquisition means or the result information acquired by the result-information acquisition means in a predetermined form on the display unit.

2. The apparatus according to claim 1, wherein
the content includes programs for broadcast, and
the information processing apparatus further comprises:
program-information acquisition means for acquiring program information regarding the programs from an information management device connected via a network; and
program-listing generation means for generating display data for a program listing on the basis of the program information acquired by the program-information acquisition means.

3. The apparatus according to claim 2, wherein the display means displays part or all of the schedule information acquired by the schedule-information acquisition means or the result information acquired by the result-information acquisition means together with the program listing corresponding to the display data generated by the program-listing generation means.

4. The apparatus according to claim 3, wherein the schedule information acquired by the schedule-information acquisition means or the result information acquired by the result-information acquisition means is displayed as a predetermined mark or character on the program listing.

5. The apparatus according to claim 2, wherein the display means displays part or all of the schedule information acquired by the schedule-information acquisition means or the result information acquired by the result-information acquisition means as a list.

6. The apparatus according to claim 5, wherein the schedule information acquired by the schedule-information acquisition means or the result information acquired by the result-information acquisition means is displayed as a predetermined mark or character on the list.

7. The apparatus according to claim 2, further comprising:
GUI display control means for controlling display of a GUI that specifies a program on the basis of the program listing displayed on the display unit.

8. The apparatus according to claim 7, further comprising:
schedule setup instruction means for instructing the content processing apparatus to set up a schedule for recording or viewing the program specified by the GUI.

9. The apparatus according to claim 1, wherein the information processing apparatus is integrated with a mobile phone and communicates with the content processing apparatus using a communication function of the mobile phone.

10. A method for processing information through an information processing apparatus that communicates with a content processing apparatus for executing a process related to recording or playback of content and has a display unit for displaying information, the method comprising the steps of:
acquiring schedule information regarding a recording and/or viewing schedule set up in the content processing apparatus;
acquiring result information regarding the result of recording performed in accordance with the schedule information set up in the content processing apparatus; and
displaying the acquired schedule information or result information in a predetermined form on the display unit.

11. A computer-readable program that allows an information processing apparatus to process information, the information processing apparatus communicating with a content processing apparatus for executing a process related to recording or playback of content and having a display unit for displaying information, the program comprising the steps of:
controlling acquisition of schedule information regarding a recording and/or viewing schedule set up in the content processing apparatus;
controlling acquisition of result information regarding the result of recording performed in accordance with the schedule information set up in the content processing apparatus; and
controlling display of the acquired schedule information or result information in a predetermined form on the display unit.

12. A recording medium that the program according to claim 11 is recorded.

13. A content processing apparatus that performs a process related to recording or playback of content and communicates with an information processing apparatus, the content processing apparatus comprising:
schedule setup means for setting up a schedule for recording or playback of the content on the basis of information transmitted from the information processing apparatus;
schedule-information storage means for storing information regarding the schedule set up by the schedule setup means;
schedule execution means for executing a recording or playback process corresponding to the schedule on the basis of the information stored in the schedule-information storage means; and
result determination means for determining whether the recording process executed by the schedule execution means has succeeded, wherein
the information stored in the schedule-information storage means is transmitted to the information processing apparatus in response to a request transmitted from the information processing apparatus, and
information regarding the result of recording determined by the result determination means is transmitted to the information processing apparatus in response to a request transmitted from the information processing apparatus.

14. A method for processing content through a content processing apparatus that performs a process related to recording or playback of content and communicates with an information processing apparatus, the method comprising the steps of:
setting up a schedule for recording or playback of the content on the basis of information transmitted from the information processing apparatus;
storing information regarding the schedule;
transmitting the stored information regarding the schedule to the information processing apparatus in response to a request transmitted from the information processing apparatus; and
transmitting information regarding the result of recording to the information processing apparatus in response to a request transmitted from the information processing apparatus, the information regarding the result of recording indicating whether the recording executed on the basis of the stored information regarding the schedule has succeeded.

15. An information processing apparatus that communicates with a content processing apparatus for executing a process related to recording or playback of content and has a display unit for displaying information, the information processing apparatus comprising:
a schedule-information acquisition section acquiring schedule information regarding a recording and/or viewing schedule set up in the content processing apparatus;
a result-information acquisition section acquiring result information regarding the result of recording performed in accordance with the schedule information set up in the content processing apparatus; and
a display section displaying the schedule information acquired by the schedule-information acquisition section or the result information acquired by the result-information acquisition section in a predetermined form on the display unit.

16. A content processing apparatus that performs a process related to recording or playback of content and communicates with an information processing apparatus, the content processing apparatus comprising:
a schedule setup section setting up a schedule for recording or playback of the content on the basis of information transmitted from the information processing apparatus;
a schedule-information storage section storing information regarding the schedule set up by the schedule setup section;
a schedule execution section executing a recording or playback process corresponding to the schedule on the basis of the information stored in the schedule-information storage section; and
a result determination section determining whether the recording process executed by the schedule execution section has succeeded, wherein
the information stored in the schedule-information storage section is transmitted to the information processing apparatus in response to a request transmitted from the information processing apparatus, and
information regarding the result of recording determined by the result determination section is transmitted to the information processing apparatus in response to a request transmitted from the information processing apparatus.
